(19) United States
(12) Patent Application Publication
(10) Pub. No.: US 2009/0146898 A1
(43) Pub. Date: Jun. 11, 2009

(54) Antenna Module-Use Magnetic Core Member, Antenna Module, and Portable Information Terminal Having the Same

(75) Inventors: Hiraku Akiho, Miyagi (JP); Isao Takahashi, Miyagi (JP); Toshiaki Sugawara, Miyagi (JP); Toshiaki Yokota, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/568,061

(22) PCT Filed: Apr. 25, 2005
(86) PCT No.: PCT/JP2005/008321

§ 371 Date: Feb. 6, 2009

(30) Foreign Application Priority Data
Apr. 27, 2004 (JP) 2004-131925
Dec. 28, 2004 (JP) 2004-380367

(51) Int. Cl. H01Q 1/00; H01F 3/00

(52) U.S. Cl. 343/787; 335/297

(57) ABSTRACT

There are provided an antenna module-use magnetic core member, an antenna module and a portable information terminal provided with the same, capable of improving a communication distance without increasing a module thickness. In an antenna module (1) in which a sheet-formed magnetic core member (4) is stacked on an antenna substrate (2) on which a looped antenna is formed, one having a performance index, expressed by μ′×Q, of 300 or higher when Q is a reciprocal of a loss factor (tan δ=μ″/μ′) expressed by a real part μ′ and an imaginary part μ″ of a complex permeability at an applied frequency is used as the magnetic core member (4).

### TECHNICAL FIELD

The present invention relates to a antenna module-use magnetic core member suitable for use with a contactless IC tag and the like utilizing RFID (Radio Frequency identification) technologies, an antenna module, and a portable information terminal equipped with the antenna module.

### BACKGROUND ART

Conventionally, known as a contactless IC card and identification tag (hereinafter these are collectively called a “contactless IC tag”) utilizing RFID technologies are those having an information recording IC chip and a resonance capacitor electrically connected to an antenna coil. The contactless IC tag is configured as follows. Radio waves at a predetermined frequency are transmitted from a transmission/reception antenna of a reader/writer to the antenna coil to activate the contactless IC tag, and the contactless IC tag is identified or monitored by reading information recorded in the IC chip in response to a read command on radio wave data communication or by judging whether the IC tag resonates with radio waves at a particular frequency. In addition, many contactless IC tags are configured to update read information and write history information and the like.

As a conventional antenna module mainly used for an identification tag, there is one having a magnetic core member is inserted into an antenna coil wound in a spiral shape in a flat plane, generally in parallel to the flat plane of the antenna coil (refer to Patent Document 1 (Japanese Patent Application Publication (KOKAI) No. 2000-48152)). The magnetic core member of this antenna module is made of a high permeability material such as an amorphous sheet and an electromagnetic steel sheet and inserted generally in parallel to the flat plane of the antenna coil so that inductance of the antenna coil increases and a communication distance is improved.

Patent Document 2 (Japanese Patent Application Publication (KOKAI) No. 2000-113142) discloses an antenna module having a structure that flat plate magnetic core members are stacked in parallel to a flat plane of an antenna coil wound in a spiral shape in the flat plane. Patent Document 3 (Japanese Patent Application Publication (KOKAI) No. 2004-304370) discloses a structure that sintered ferrite is used as the material of a magnetic core member.

Portable information terminals such as PDA (personal digital assistants) and mobile phones widely prevailing nowadays are always carried by users in outdoors or other places. Accordingly, if a portable information terminal is provided with a function of a contactless IC tag, the user is not required to have, e.g., a contactless IC card in addition to the portable information terminal always carried by the user, and this is very convenient. Technologies of incorporating the function of a contactless IC tag into a portable information terminal are disclosed, for example, in Patent Document 4 (Japanese Patent Application Publication (KOKAI) No. 2003-37861) and have already been proposed by the present applicant (Japanese Patent Application 2004-042149).

Since a portable information terminal is an apparatus which has multi-functions while being compact, metallic components are mounted in a small housing at a high density. For example, a printed circuit board used in a portable information terminal has a conductive layer made of plural layers. Electronic components are mounted on a multi-layer printed circuit board at a high density. A battery pack to be used as a power source is accommodated in a portable information terminal, and metallic components such as a frame are used in the battery pack.

Therefore, a contactless IC tag-use antenna module provided in the housing of a portable information terminal has a more degraded communication performance such as tendency of a short communication distance than the antenna module before provided in the housing, because of the influences of metallic components employed in the housing.

As the communication distance of the antenna module becomes short, there arise the requirements for moving the antenna module toward a reader/writer as near as possible in actual use, which may possibly damage convenience of a contactless card system capable of transferring information easily and quickly. It is considered that a communication distance of at least 100 mm is necessary even in a case where the antenna module is accommodated in the housing of the portable information terminal. This conforms with specifications of an automatic train ticket examination contactless IC card system presently used locally.

### DISCLOSURE OF THE INVENTION

In order to improve a communication distance of an antenna module, high permeability magnetic powders have been used conventionally as the material of a magnetic core member. In a case where a sheet or plate made by mixing magnetic powders with a binder is used as a magnetic core member, a permeability of the whole magnetic core member can be increased by using magnetic powders of a large particle size.

However, as the particle size of magnetic powders is made large, a power loss due to an eddy current loss in the magnetic core member becomes considerable, resulting in a lowered IC read voltage and a short communication distance. More specifically, as a magnetic substance is magnetized in a high frequency magnetic field, there occurs a change in magnetic fluxes in correspondence with the frequency. In this case, according to the law of electromagnetic induction, there is generated an electromotive force having a direction of cancelling out the magnetic flux change. Induction current caused by the generated electromotive force is converted into a Joule heat in the magnetic substance. This is an eddy current loss.

In order to reduce an eddy current loss while maintaining high a permeability of a magnetic core member, almost all conventional cases take a measure of limiting a large particle size of magnetic powders and reducing an absolute amount (mixture ratio) of magnetic powders to be mixed.

However, reducing the absolute amount of magnetic powders leads to a thick and large magnetic core member in order to retain necessary magnetic characteristics. This results in increasing the thickness of an antenna module. For example, in the structure of the above-described magnetic core member, a sheet thickness necessary for a communication distance of 100 mm is at least over 1 mm for a magnetic core member itself. If a substrate for supporting an antenna coil and a shield plate for avoiding the influence of metallic portions in the housing are stacked thereon, the module becomes thicker.

Recent demands for a smaller and thinner portable information terminal are increasing more and more. There is no space left in the housing for accommodating an antenna module of a large size or thickness. As described above, it is necessary for an antenna module employed in a compact electronic apparatus such as a portable information terminal to satisfy two contradictory requirements: further improvements on a communication distance and further reduction of a module thickness.

The present invention has been made to solve the above-described problems and has an issue of providing a antenna module-use magnetic core member, an antenna module, and a portable information terminal equipped with the module, capable of improving a communication distance without thickening the module.

In order to solve this issue, the present inventors have vigorously studied, paid attention to a loss factor of a magnetic core member at an applied frequency (e.g., 13.56 MHz), and found that a communication distance can be improved without thickening the module, by using a magnetic core member in which a product of a reciprocal of the loss factor and a real part of a complex permeability is a predetermined value or larger.

Namely, the present invention provides a antenna module-use magnetic core member to be stacked on a looped antennal coil and made by mixing magnetic powders with a binder to be a sheet or plate, the magnetic core member being characterized in that the magnetic core member having a performance index, expressed by μ′×Q, of 300 or higher is used, where a reciprocal of a loss factor (tan δ=μ″/μ′) expressed by a real part μ′ and an imaginary part μ″ of a complex permeability at an applied frequency is set as Q.

The above-mentioned magnetic core member having the performance index of 300 or higher can reduce a power loss of the antenna module to be caused by an eddy current loss, can improve a communication distance without increasing a layer thickness of the magnetic core member.

The principle of the present invention will be described hereunder. Generally, as a high frequency magnetic field is applied to a soft magnetic substance (hereinafter simply called a magnetic substance) which is a high permeability material, the magnetic substance is magnetized by a magnetization mechanism such as displacement of magnetic domain walls and rotating magnetization. In this case, a permeability indicating magnetization easiness is indicated by a complex magnetic permeability and expressed by the following equation (1):

μ=μ′−i·μ″ (1)

Herein, μ′ is a real part of the permeability and indicates the components capable of following an external magnetic field, whereas μ″ is an imaginary part of the permeability, indicates the components unable to follow an external magnetic field and having a phase delayed by 90°, and is called a loss term of the permeability. It is noted that i is an imaginary unit.

There is a tight relation between the real part and the imaginary part of a permeability, and material having a larger real part of a permeability has a larger imaginary part. It is known that, in a case where a magnetic substance is magnetized by applying a high frequency magnetic field, the permeability lowers as the frequency becomes higher. A loss factor of a magnetic substance at an applied frequency can be represented by using the real part μ′ and the imaginary part μ″ of the complex permeability shown in the equation (1), and is given by the following equation (2):

tan δ=μ″/μ′ (2).

A high frequency loss of a magnetic substance by dynamic magnetization is equivalent to the above loss factor and can be expressed as a sum of the energy losses of three types, as given by the following equation (3):

tan δ=tan δh+tan δe+tan δr (3).

Herein, tan δh is a hysteresis loss and a work amount of a magnetization change indicated by a hysteresis curve, and increases in proportion to a frequency, and tan δe is an eddy current loss which is an energy loss consumed as Joule heat generated by an eddy current induced in material in correspondence with a magnetic flux change. It is noted that tan δr is a residual loss which does not correspond to any one of the above-described losses.

An eddy current loss (tan δe) in a high frequency magnetic field at 13.56 MHz is influenced by a conductivity and increases in proportion to an applied frequency, as given by the following equation (4):

tan δe=e2·μf·σ (4).

Herein, e2 is a coefficient, μ is a permeability, f is an applied frequency, and σ is a conductivity of magnetic powders.

As described above, the eddy current loss (tan δe) of a magnetic core member made of a magnetic substance can be suppressed low if magnetic powders having a small conductivity are used, in other words, if magnetic powders having a large resistivity are used. It can be understood that using magnetic powders having a small eddy current loss can reduce the loss term μ″ components of the complex permeability of the magnetic core member and can contribute to reduction in a loss factor.

A suitable conductivity of the magnetic core member changes with the type and particle size of magnetic powders to be used, a mixture ratio and the like, and cannot be limited specifically. Therefore, in the present invention, in place of the conductivity, a performance index is used, which is defined as a product of Q and μ′, in a case where a reciprocal of a loss factor (μ″/μ′) represented by the real part μ′ and imaginary part μ″ of a complex permeability of a magnetic core member at an applied frequency is set as Q.

Examples of the magnetic core member having the performance index of 300 or higher are: in a case of magnetic powders of Sendust (containing Fe—Si—Al), obtained are a magnetic core member having μ′=60 [H/m], μ″=12 [H/m] and a performance index of 300 at a mixture ratio of 45 [vol %] of; and a magnetic core member having μ′=77 [H/m], μ″=17 [H/m] and a performance index of 349 at a mixture ratio of 50 [vol %].

Another example in a case of magnetic powders containing Fe—Si—Cr (10 wt % Si) is a magnetic core member having μ′=45 [H/m], μ″=1.0 [H/m] and a performance index of 2025 at a mixture ratio of 50 [vol %]. Other magnetic powders may be Fe—Si containing amorphous, ferrite and the like.

The magnetic core member can be manufactured by mixing magnetic powders with a binder and forming into a sheet or plate shape. In forming into a sheet or plate shape, injection molding is preferable. As the binder, synthetic resin materials are applicable including nylon 12, PPS (polyphenylene sulfide), polyethylene and the like.

A sintered substance of ferrite powders may be used as the magnetic core member. It is preferable that ferrite material to be used has a material composition that a resonance frequency of rotation magnetic resonance is on the higher frequency side than the applied frequency. Accordingly, influence by natural resonance of ferrite material in an applied frequency band can be avoided and stable communication characteristics can be retained.

By manufacturing an antenna module by using the magnetic core member having the above-described structure, a thickness of the magnetic core member can be suppressed to 1 mm or thinner while a communication distance of 100 mm or longer is ensured in the state that the antenna module is accommodated in a housing of, e.g., a portable information terminal. Thinning the antenna module can be realized easily.

### BRIEF DESCRIPTION OF DRAWINGS

FIG. 1 is an exploded perspective view showing a structure of an antenna module 10 according to an embodiment of the present invention.

FIG. 2 is a cross sectional side view showing a main portion of the antenna module 10.

FIG. 3 is a schematic diagram showing an internal structure, as viewed sideways, of a portable information terminal 1 in which the antenna module 10 is built.

FIG. 4 is a partially cut away back view of the portable information terminal 1.

FIG. 5 is a diagram showing a relation between a frequency (abscissa) and μ′ and μ″ (ordinate) when a high frequency magnetic field is applied to magnetic powders of Fe-5% Si and magnetic powders of Fe-10% Si.

FIG. 6 is a diagram showing the relation between a Si dope amount (abscissa) relative to Fe and a resistivity (ordinate).

FIG. 7 is a schematic diagram showing the relation between a permeability and a critical frequency of ferrite material.

FIG. 8 is a ternary composition diagram of Ni—Zn—Fe₂O₃ of Ni—Zn—Cu containing ferrite material.

FIG. 9 is a diagram showing the frequency characteristics of permeabilities μ′ and μ″ of Ni—Zn—Cu ferrite bulk of three samples having different composition ratios.

FIG. 10 is a diagram showing the frequency characteristics of permeabilities μ′ and μ″ when Ni—Zn—Cu ferrite of three samples having different composition ratios is stacked.

FIG. 11 is a diagram showing a communication distance and a performance index of each sample of the magnetic core member made of composite material according to a first embodiment of the present invention.

FIGS. 12A and 12B are process diagrams illustrating a manufacture method for a magnetic core member made of sintered ferrite according to a second embodiment of the present invention.

FIG. 13 is a frequency characteristic diagram comparing communication distances of one sample of a magnetic core member made of composite material and one sample of a magnetic core member made of stacked ferrite.

FIG. 14 is a cross sectional view showing an example of the structure of an antenna module 20 using a magnetic core member made of stacked ferrite.

### BEST MODE FOR CARRYING OUT THE INVENTION

Embodiments of the present invention will be described with reference to the accompanying drawings.

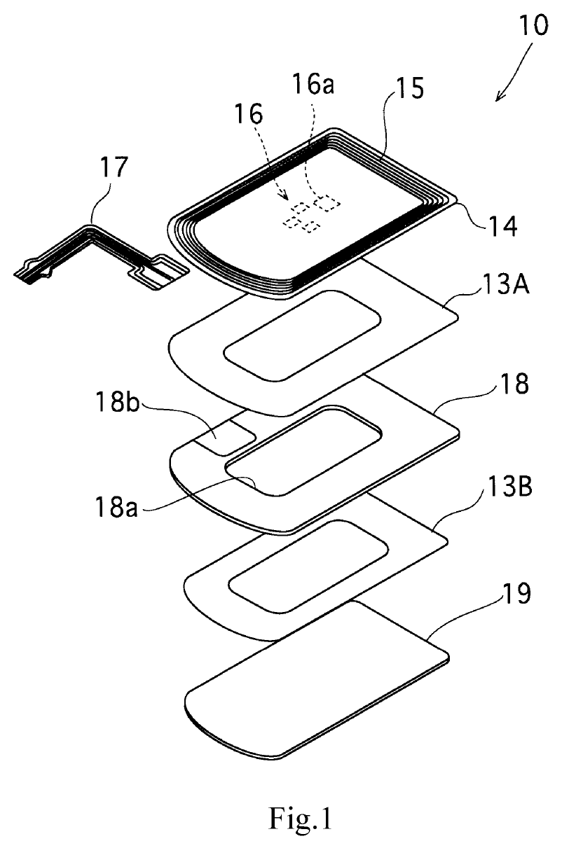

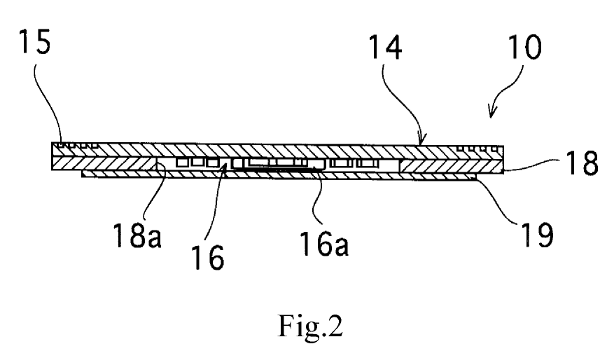

FIGS. 1 and 2 are an exploded perspective view and a cross sectional side view showing the structure of an antenna module 10 for contactless data communication according to an embodiment of the present invention.

The antenna module 10 has a stacked structure of a base substrate 14 as a support member, a magnetic core member 18 and a metal shield plate 19. The base substrate 14 and magnetic core member 18 are stacked with a double coated adhesive sheet 13A in between, and the magnetic core member 18 and metal shield plate 19 are stacked with a double coated adhesive sheet 13B in between. In FIG. 2, illustration of the double coated adhesive sheets 13A and 13B are omitted.

The base substrate 14 is an insulating flexible substrate made of a plastic film of polyimide, polyethylene terephthalate (PET), polyethylene naphthalate (PEN) or the like. The base substrate 14 may be a rigid substrate made of glass epoxy or the like.

An antenna coil 15 wound in a loop shape in a flat plane is mounted on the base substrate 14. The antenna coil 15 is used for a contactless IC tag function, and inductively coupled to an antenna unit of an external reader/writer (not shown) for communications. The antenna coil 15 is made of a metal pattern of copper, aluminum or the like patterned on the base substrate 14.

In this embodiment, the antenna coil 15 is constituted of a loop portion wound in the flat plane and a wiring portion for electrical connection to a signal processing circuit unit 16 to be described later. In the figure, only the loop portion is shown.

A second antenna coil may be formed on the antenna module 10 for a reader/write function. In this case, the second antenna coil may be formed on the base substrate 14, for example, on an inner circumferential side of the antenna coil 15.

The signal processing circuit unit 16 is mounted on the surface of the base substrate 14 on the side of the magnetic core member 18. This signal processing circuit unit 16 is disposed on an inner side of the antenna coil 15 and electrically connected to the antenna coil 15.

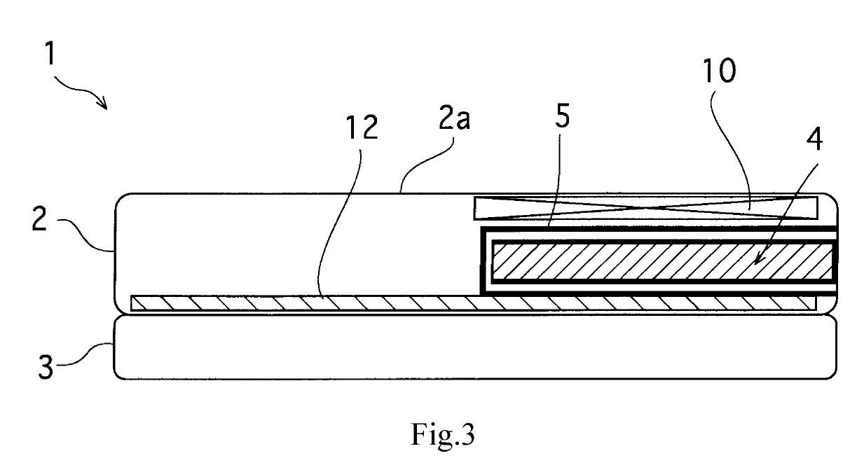

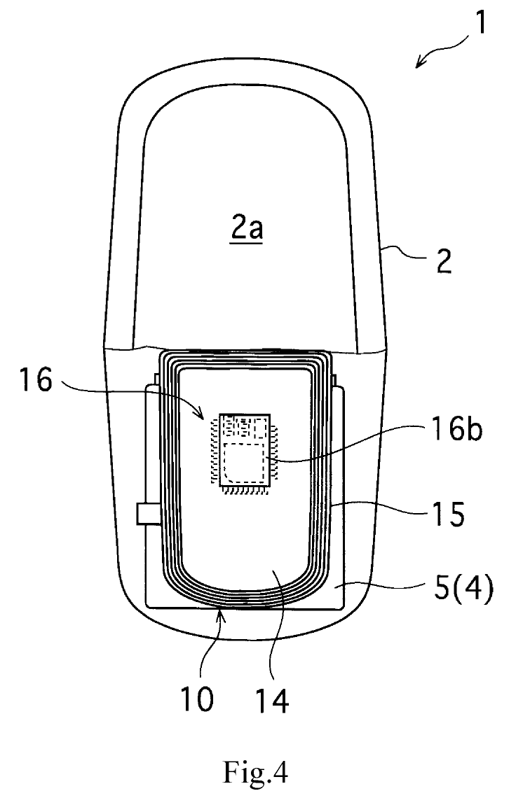

The signal processing circuit unit 16 is constituted of an IC chip 16a mounting a signal processing circuit and storing information necessary for the contactless data communication, and electric and electronic components such as a tuning capacitor. The signal processing circuit unit 16 may be constituted of a plurality of components as shown in FIGS. 1 and 2, or may be constituted of a single component 16b as shown in FIG. 4. The signal processing circuit unit 16 is connected to a printed circuit board 12 (FIG. 3) of a portable information terminal 1 to be described later, via an external connection portion 17 to be mounted on the base substrate 14.

The magnetic core member 18 may be an injection molding member formed by mixing or filling soft magnetic powders with or in insulating binder such as synthetic resin material and rubber, and forming into a sheet shape or plate shape. Soft magnetic powders may be Sendust (containing Fe—Al—Si), Permalloy (containing Fe—Ni), amorphous (containing Fe—Si—B or the like), ferrite (Ni—Zn ferrite, Mn—Zn ferrite or the like), and the like, and these materials are selectively used in accordance with a communication performance, use application and the like.

As will be later described, the magnetic core member 18 may be formed with a sintered ferrite plate obtained by coating metal paste formed by dispersing fine powders of ferrite material into organic solvent, in a sheet shape, and thereafter thermally resolving the organic solvent and processing through main sintering.

The magnetic core member 18 functions as a magnetic core of the antenna coil 15 and also avoids electromagnetic interference between the antenna coil 15 and the metal shield plate 19 by being inserted between the base substrate 14 and the lower metal shield plate 19. An opening 18a is formed through the magnetic core member 18 in a center area of the magnetic core member 18 to accommodate the signal processing circuit unit 16 mounted on the base substrate 14. On one side of the magnetic core member 18, a runout 18b is formed for the external connection portion 17 to be laminated on the base substrate 14.

The details of the magnetic core member 18 will be later described.

The metal shield plate 19 is made of a stainless steel plate, a copper plate, an aluminum plate or the like. As will be later described, the antenna module 10 of this embodiment is accommodated in a terminal main body 2 of the portable information terminal 1 at a predetermined position. Therefore, the metal shield plate 19 is provided in order to protect the antenna coil 15 from electromagnetic interference with metallic portions (components, wirings) on the printed circuit board 12 in the terminal main body 2.

The metal shield plate 19 is also used for coarse adjustment of a resonance frequency (in this example, 13.56 MHz) of the antenna module 10 so as not to make a large change in the resonance frequency of the antenna module 10 between the antenna module 10 in a discrete state and the antenna module 10 assembled in the terminal main body 2.

FIGS. 3 and 4 are schematic diagrams showing how the antenna module 10 having the structure described above is assembled in the portable information terminal 1. FIG. 3 is a schematic diagram showing the inside of the terminal main body 2 as viewed sideways, and FIG. 4 is a partially broken view showing the inside of the terminal main body 2 as viewed from the back side.

The portable information terminal 1 shown in the figures is a portable phone having the terminal main body 2 and a panel unit 3 rotatably mounted on the terminal main body 2. In FIG. 3, the terminal main body 2 constitutes a housing unit made of a synthetic resin material, and the surface thereof on the side of the panel unit 3 is an operation plane on which ten-key input buttons and the like are mounted although not shown.

Built in the terminal main body 2 are the printed circuit board 12 as a control board for controlling the function or operation of the portable information terminal 1 and a battery pack 4 for supplying a power. The battery pack 4 is, for example, a lithium ion battery and has a rectangular parallelepiped shape as a whole, and its outer frame is made of a metal material such as aluminum. The battery pack 4 is disposed in a partition member 5 made of plastic and formed in the terminal main body 2.

The antenna module 10 is accommodated in the terminal main body 2. Particularly in this embodiment, the antenna module 10 is accommodated at a position just above the partition member 5 accommodating the battery pack 4, and the antenna coil 15 faces a back surface 2a of the terminal main body 2. It is noted that the position where the antenna module 10 is accommodated is not limited to that described above.

For data communications between the antenna module 10 and an external reader/write (not shown), the back surface 2a of the terminal main body 2 of the portable information terminal 1 is moved near to the antenna portion of the reader/writer. As electromagnetic waves or a high frequency magnetic field transmitted from the antenna portion of the reader/writer passes through the antenna coil 15 of the antenna module 10, induction current corresponding to the intensity of the electromagnetic waves or high frequency magnetic field is generated in the antenna coil 15. This induction current is rectified in the signal processing circuit unit 16 and converted into a read voltage for reading information recorded in an IC chip 16a. The read information is modulated in the signal processing circuit unit 16 and transmitted to the antenna portion of the reader/writer via the antenna coil 15.

Next, detailed description will be made on the magnetic core member 18 constituting the antenna module 10.

The magnetic core member 18 may be made as an injection molding in a sheet shape or plate shape, made of composite material formed by mixing or filling soft magnetic powders (hereinafter called magnetic powders) of high permeability material with or in an insulating material (binder) such as synthetic resin.

Magnetic powders to be used are, for example, crystalline alloy such as Sendust (containing Fe—Al—Si) and Permalloy (containing Fe—Ni), amorphous alloy (containing Co—Fe—Si—B or the like), ferrite (Ni—Zn ferrite, Mn—Zn ferrite or the like), and the like. The particle shape may be a flat plate shape, a needle shape, a flake shape or the like, but is not limited to a particular shape.

In the present invention, the magnetic core member 18 formed by mixing magnetic powders with binder is considered as a single magnetic member. The magnetic member is structured in such a manner that the magnetic core member 18 has a performance index, defined by μ′×Q, of 300 or higher, assuming that a reciprocal of a loss factor (tan δ=μ″/μ′) expressed by a real part μ′ and an imaginary part μ″ of a complex permeability (refer to the above equation (1)) at an applied frequency (in this example, 13.56 MHz) of the magnetic member is Q (μ″/μ′).

In order to improve the communication distance of the antenna module 10, it is necessary to suppress eddy current loss components generated in the magnetic core member 18. To this end, a variety of selection judgments are therefore necessary such that magnetic powders having a small conductivity are selected, a mixture ratio of magnetic powders to binder is adjusted, a particle size is made small, and so on. However, in the present invention, the performance index of the magnetic core member 18 as a finished product is evaluated so that it is possible to establish the criterion of whether a target communication distance can be ensured.

As indicated by the embodiments to be described later, use of a magnetic core member having a performance index of 300 or higher ensures an antenna module communication distance (communication distance in a state incorporated in a portable information terminal) of 100 mm. Further, since it is possible to increase a permeability of the magnetic core member 18 without increasing a sheet thickness, a thin and light antenna module can be structured and a mount space for the antenna module in the housing can be reduced. For example, in order to ensure a communication distance of 100 mm, a conventional magnetic core member requires a sheet thickness over 1 mm, whereas a sheet thickness of about 0.5 mm is sufficient according to the present invention.

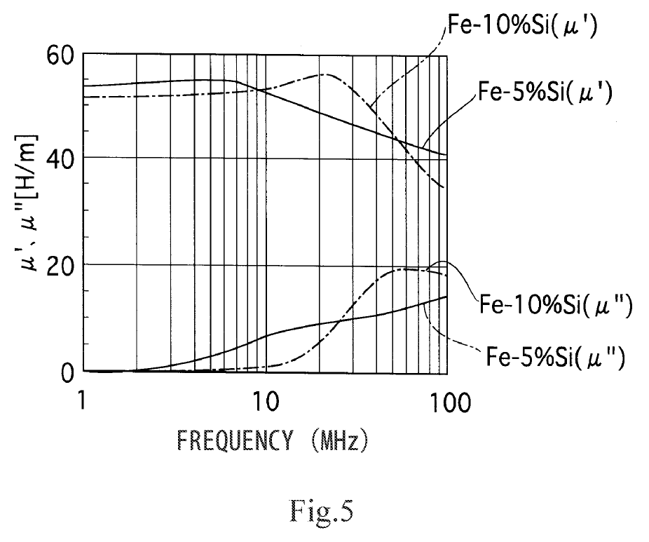

The real and imaginary parts μ′ and μ″ of the magnetic powders constituting the magnetic core member change with a composition ratio and an applied frequency, even in the same magnetic powders, e.g., those of alloy which contains Fe—Si—Cr. FIG. 5 shows the relation between a frequency (abscissa) and μ′ and μ″ (ordinate) while a high frequency magnetic field is applied to magnetic powders of Fe-5% Si and magnetic powders of Fe-10% Si. Tendency understood from comparison between both magnetic powders is that the magnetic powders of Fe-10% Si have a smaller loss (μ″) in a frequency band of 13.56 MHz, whereas the magnetic powders of Fe-10% Si have a larger loss as the frequency becomes high.

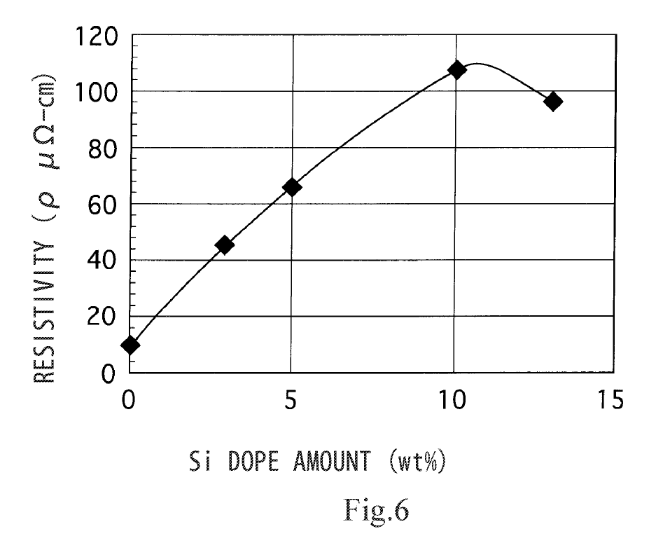

In order to reduce the eddy current loss of the magnetic core member, as the magnetic powders constituting the magnetic core member, those having a high resistivity (low conductivity) are preferable. If the resistivity is used as a criterion, although it is obvious that the magnetic powders can be selected on the basis of the kind thereof, another way of adjusting the resistivity depending on a composition ratio of magnetic powders may be applied. FIG. 6 shows the relation between a Si dope amount (abscissa) relative to Fe and a resistivity (ordinate). As apparent from this diagram, it can be understood that a high resistivity is obtained at a Si dope amount of 10 to 13 wt %.

If the conductivity of magnetic powders is used as the criterion, it is effective to reduce a particle size in order to reduce the eddy current loss. Namely, it is necessary to reduce the particle size of magnetic powders particularly for those having a high conductivity, and the particle size can be made large for those magnetic powders having a low conductivity.

For example, magnetic powders having a conductivity of 1.11E+6 (1.11×10⁶) or smaller are made to have a particle distribution of 50 μm or smaller, magnetic powders having a conductivity of 0.909E+6 or smaller are made to have a particle distribution of 100 μm or smaller, and magnetic powders having a conductivity of 0.1E+6 or smaller are made to have a particle distribution of 200 μm or smaller. A flat plane shape is used as the particle shape of magnetic powders. A mixture ratio is preferably 40 to 60 vol %.

On the other hand, the magnetic core member 18 can be formed with a sintered ferrite plate obtained by forming metal paste made by dispersing fine powders of ferrite material into organic solvent, in a sheet shape, and thereafter thermally resolving the organic solvent and processing through main sintering. This sintered ferrite sheet may be a lamination structural body by laminating a plurality of sintered ferrite sheets with insulating layers being inserted therebetween.

Also in this case, the magnetic core member 18 is structured in such a manner that the magnetic core member 18 has a performance index, defined by μ′×Q, of 300 or higher, where Q (μ″/μ′) is a reciprocal of a loss factor (tan δ=μ″/μ′) expressed by a real part μ′ and an imaginary part μ″ of a complex permeability at an applied frequency of the magnetic core member.

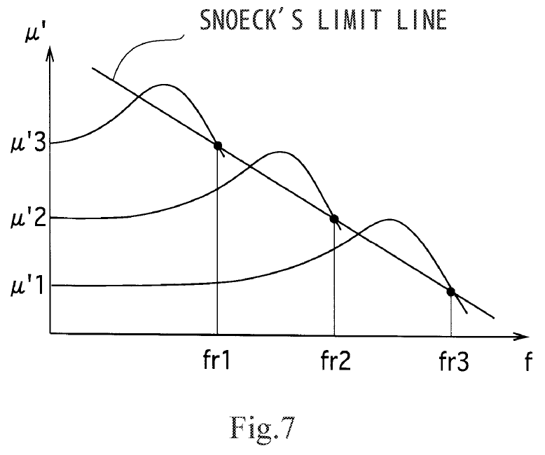

Generally, although a high frequency magnetic material is required to have a high initial permeability and a high limit frequency, it is also important that the high frequency magnetic material has the frequency characteristics having a stable initial permeability in a high frequency band. However, as schematically shown in FIG. 7, the frequency characteristics of spinel type ferrite such as Ni—Zn containing ferrite has the relation that if the initial permeability (μ′) is high, the limit frequency (fr) lowers, and if the initial permeability is low, the limit frequency increases. The limit frequencies are approximated by a straight line called a Snoeck's limit line. A limit frequency of ferrite in a high frequency band is determined by a resonance frequency of rotation magnetic resonance (natural resonance).

Therefore, in a case where the antenna module 10 is used at an applied frequency of 13.56 MHz, the natural resonance (rotation magnetic resonance) of the magnetic core member 18 is required to be on the higher frequency side than the frequency band of 13.56 MHz. Otherwise, the natural resonance phenomenon becomes a dominant factor of the μ″ components, and stable communication characteristics of the antenna module 10 cannot be obtained. Therefore, in a case where the magnetic core member 18 is to be made of a ferrite material, there is a limit in a magnitude of μ′ of the complex permeability, and it is not preferable to use the material exceeding the limit because μ″ increases and the performance index lowers.

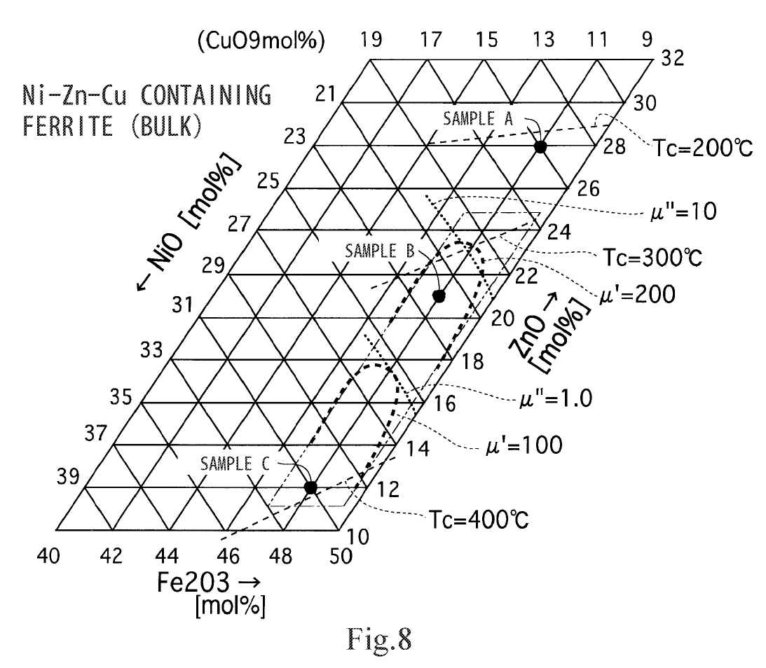

The permeability (μ′, μ″) of ferrite material changes greatly with a composition of constituent elements of the ferrite material. FIG. 8 is a ternary composition diagram of a case of NiO—ZnO—Fe₂O₃ at 9 mol % of CuO with regard to a ferrite material (bulk state) containing Ni—Zn—Cu. It can be seen from FIG. 8 that μ′ and μ″ of the ferrite material containing Ni—Zn—Cu become smaller as the composition ratio of NiO is higher, and that the natural resonance frequency can be positioned on the higher frequency side than the applied frequency (in this example, 13.56 MHz) of the antenna module 10. In this case, the eddy current loss becomes dominant in the μ″ components of the magnetic material.

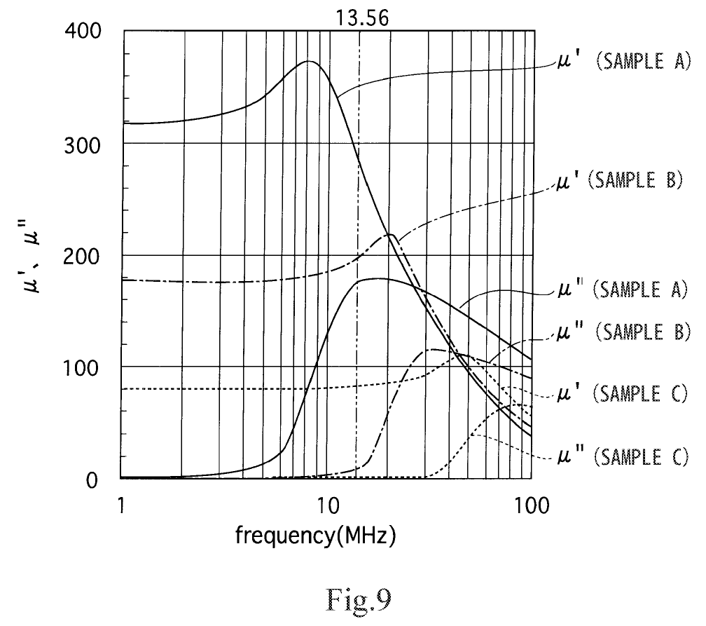

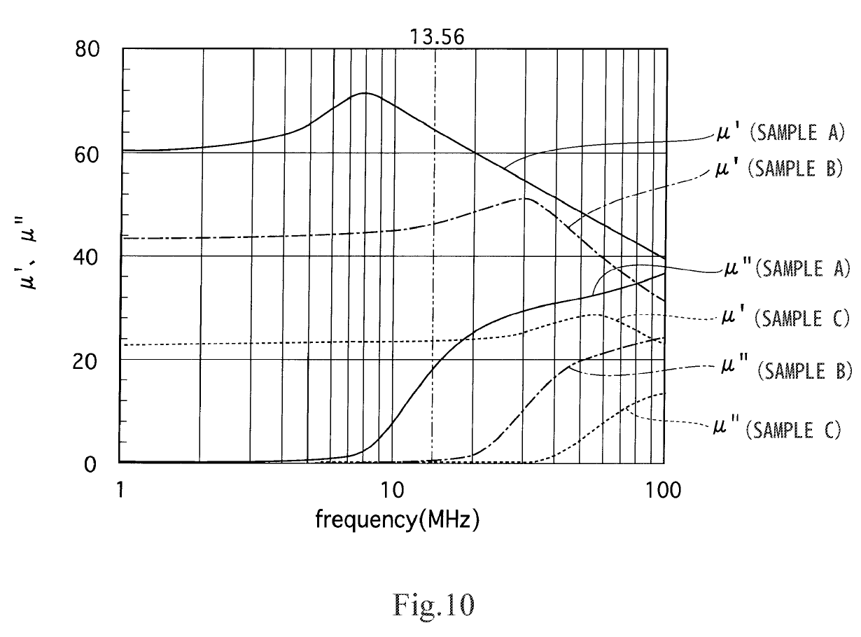

In a case where the magnetic core member 18 is made of sintered ferrite, μ′ and μ″ become smaller if a sintered powder sheet member is used, than using a ferrite material in a bulk state. FIGS. 9 and 10 are diagrams showing the frequency characteristics of permeabilities μ′ and μ″ of bulk members and sintered powder members (four-layer lamination member to be described later) of samples A, B and C at three composition points shown in FIG. 8.

If the applied frequency of the antenna module 10 is 13.56 MHz, a ferrite material containing Ni—Zn—Cu suitable for the magnetic core member 18 is assumed to be a sintered powder member of bulk ferrite which contains Fe₂O₃ of 47.0 to 49.8 mol %, NiO of 16.0 to 33.0 mol %, ZnO of 11.0 to 25.0 mol % and CuO of 7.0 to 12.0 mol % (a rectangular range indicated by two-dot chain line in FIG. 8).

Herein, if Fe₂O₃ exceeds 49.8 mol %, μ′ lowers, and if Fe₂O₃ becomes smaller than 47.0 mol %, a Curie point (Tc: magnetic transformation point) lowers, thereby limiting the use environment. If NiO exceeds 33.0 mol %, μ′ lowers, and if NiO becomes smaller than 16.1 mol %, μ″ (influence by natural resonance) increases to be unable to obtain stable communication characteristics.

If CoO of 0.1 to 1.0 wt % is contained in ferrite containing Ni—Zn—Cu, the temperature characteristics can be stabilized and it is possible to suppress a change in the communication characteristics to be caused by a temperature change of the use environment of the antenna module 10.

### FIRST EXAMPLE

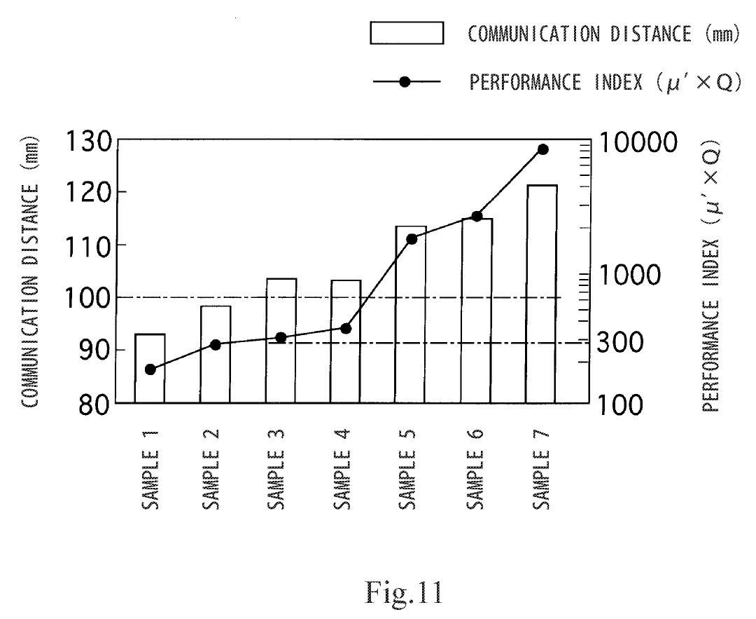

Antenna modules 10 having the structure shown in FIG. 1 were manufactured by preparing a plurality of samples of the magnetic core member made of a composite material having different types or mixture ratios of magnetic powders, a reciprocal Q of the loss factor and a performance index (Q×μ′) were calculated on the basis of μ′ and μ″ at the time of applying a high frequency magnetic field (13.56 MHz), and communication distances (communication distances in the antenna module state assembled in a portable information terminal) were evaluated. “Nylon 12” (trade name) was used as a binder. Experiment results are shown in FIG. 11 and Table 1.

TABLE 1

| | | SAMPLE-1 | SAMPLE-2 | SAMPLE-3 | SAMPLE-4 | SAMPLE-5 | SAMPLE-6 | SAMPLE-7 |
|---|---|---|---|---|---|---|---|---|
| | | Fe—Si—Al | Fe—Si—Cr | Fe—Si—Al | Fe—Si—Al | Fe—Si—Cr | Amorphous | Ferrite |
| Magnetic Core | μ′ (H/m) | 30 | 50 | 60 | 77 | 45 | 50 | 50 |
| Characteristics | μ″ (H/m) | 5 | 9 | 12 | 17 | 1 | 1 | 0.3 |
| | Q | 6 | 5.6 | 5 | 4.5 | 45 | 50 | 166.7 |
| | μ′ × Q | 180 | 278 | 300 | 349 | 2025 | 2500 | 8333 |
| Antenna | Communication | 92.6 | 98.2 | 103.5 | 104.5 | 114.2 | 115 | 120 |
| Characteristics | Distance (mm) | | | | | | | |
| | Coil | 3.6 | 4.3 | 4.5 | 4.4 | 4.3 | 4.3 | 4.3 |
| | Inductance | | | | | | | |
| | L(μH) | | | | | | | |
| | Coil | 12.7 | 14.6 | 15.8 | 15.8 | 10.1 | 10 | 8.5 |
| | Resistance | | | | | | | |
| | (Ω) | | | | | | | |
| | Coil Q | 24 | 25 | 24 | 24 | 36 | 37 | 43 |
| Magnetic Powder | Particle Size | 30 | 30 | 50 | 80 | 30 | 80 | 300 |
| Characteristics | D50 (μm) | | | | | | | |
| | Mixture Ratio | 40 | 50 | 45 | 50 | 50 | 50 | 50 |
| | (vol %) | | | | | | | |
| | Conductivity | 1.25 × 10⁶ | 1.43 × 10⁶ | 1.25 × 10⁶ | 1.25 × 10⁶ | 0.91 × 10⁶ | 0.71 × 10⁶ | 0.05 |
| | (s/m) | | | | | | | |
| | Resistivity | 80 × 10⁻⁸ | 70 × 10⁻⁸ | 80 × 10⁻⁸ | 80 × 10⁻⁸ | 110 × 10⁻⁸ | 140 × 10⁻⁸ | 20 |
| | (Ω · m) | | | | | | | |

In FIG. 11, a height of a bar graph of each sample indicates a communication distance, and a polygonal line indicates a performance index. In Table 1, “Coil Q” indicates a Q value of an antenna coil and is different from Q as the reciprocal of the loss factor.

Magnetic powders used for each sample will be described below briefly.

Samples 1, 3 and 4 use magnetic powders containing Fe—Si—Al having the same composition (85Fe-9.5Si-5.5Al (wt %)) and have different mixture ratios of 40 vol %, 45 vol % and 50 vol %, respectively.

Samples 2 and 5 both use magnetic powders containing Fe—Si—Cr and have different Si contents of 5 wt % and 10 wt %, respectively.

Sample 6 uses amorphous magnetic powders made of 70Co-5Fe-10Si-15B (composition ratio of wt %).

Sample 7 uses ferrite magnetic powders made of Fe₂O₃ of 49.3 (mol %), NiO of 28.9 (mol %), ZnO of 12.6 (mol %) and CuO of 9.2 (mol %).

As apparent from Table 1 and FIG. 7, the communication distance and performance index are in an approximately proportional relation, and the communication distance becomes longer as the performance index is higher. The communication distance of 100 mm or longer is ensured particularly at the performance index of 300 or higher. It can be seen from the results of Samples 1, 3 and 4 that a higher performance index can be obtained as the mixture ratio of magnetic powders is larger, and that the performance index of 300 or higher can be obtained at the mixture ratio of 45% or larger.

### SECOND EXAMPLE

Antenna modules 10 shown in FIG. 1 were manufactured by preparing a plurality of samples of the magnetic core member made of sintered ferrite containing Ni—Zn—Cu and having different material compositions, the reciprocal Q of the loss factor and the performance index (Q×μ′) were calculated on the basis of μ′ and μ″ at the time of applying a high frequency magnetic field (13.56 MHz), and communication distances (communication distances in the antenna module state assembled in a portable information terminal) were evaluated. Experiment results are shown in Table 2.

TABLE 2

| | | SAMPLE A | SAMPLE B | SAMPLE C | SAMPLE-5 |
|---|---|---|---|---|---|
| | | Ferrite | Ferrite | Ferrite | Fe—Si—Cr |
| Magnetic Core | μ′ | 65 | 42 | 20 | 45 |
| Characteristics | μ″ | 17 | 0.3 | 0.1 | 1 |
| | μ′ × Q | 250 | 5800 | 4000 | 2025 |
| Antenna | Communication | 105.6 | 122.0 | 114.5 | 114.2 |
| Characteristics | Distance (mm) | | | | |
| | Coil | 4.5 | 4.3 | 3.5 | 4.3 |
| | Inductance | | | | |
| | L(μH) | | | | |
| | Coil | 10.7 | 8.0 | 6.3 | 10.1 |
| | Resistance | | | | |
| | (Ω) | | | | |

Samples A to C were formed at three points in the composition diagram of a ferrite material containing Ni—Zn—Cu shown in FIG. 8: 48Fe₂O₃-15NiO-28ZnO-9CuO (Sample A); 48Fe₂O₃-22NiO-21ZnO-9CuO(Sample B); and 48Fe₂O₃-31NiO-12ZnO-9CuO (Sample C).

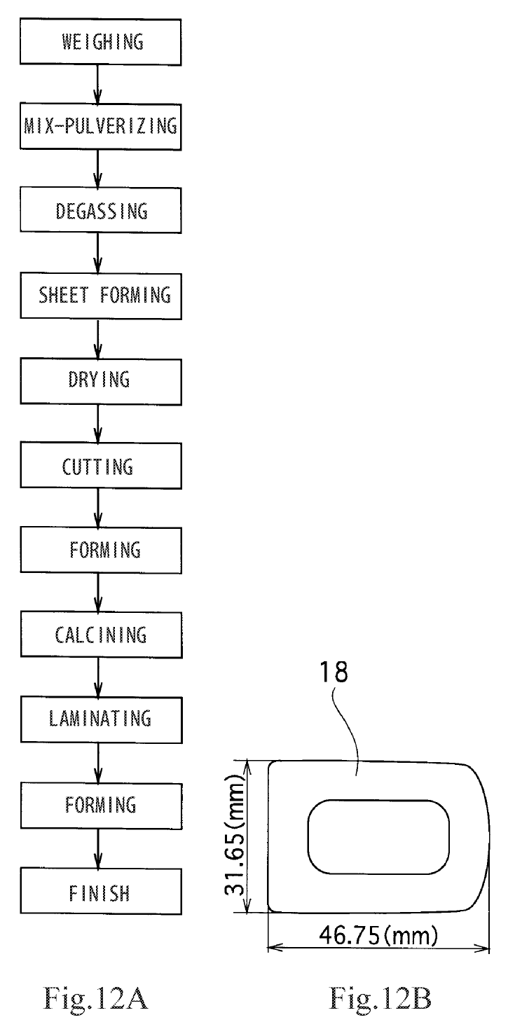

Samples A to C were manufactured by processes shown in FIG. 12A. Namely, constituent materials were weighed for each sample, mixed, pulverized and dispersed in organic solvent to make the materials in a paste state. After a degassing process, the paste was coated on a PET (polyethylene terephthalate) film to form a sheet. Thereafter, solvent components in the paste was resolved and removed by a thermal drying process. The PET film was cut at a constant size and then formed to be an outer shape of a magnetic core member, and then sintered. Next, the PET film was peeled off from the manufactured sintered ferrite sheet. Three or four sintered sheets each having a thickness of 0.15 mm were laminated with involvement of hot melt resin. After the surface of the laminated structure was covered with PET or PPS, this structure was formed in a size shown in FIG. 12B.

As shown in Table 2, Sample A has a large μ″ although μ′ is also large and the performance index is as low as 250. This may be ascribed to that the applied frequency (13.65 MHz) approaches the limit frequency of the ferrite magnetic powders and the loss factor (μ′, μ″) increases by the influence of natural resonance.

Although the experiment results indicated a communication distance over 100 mm, stable communication characteristics were not able to be obtained.

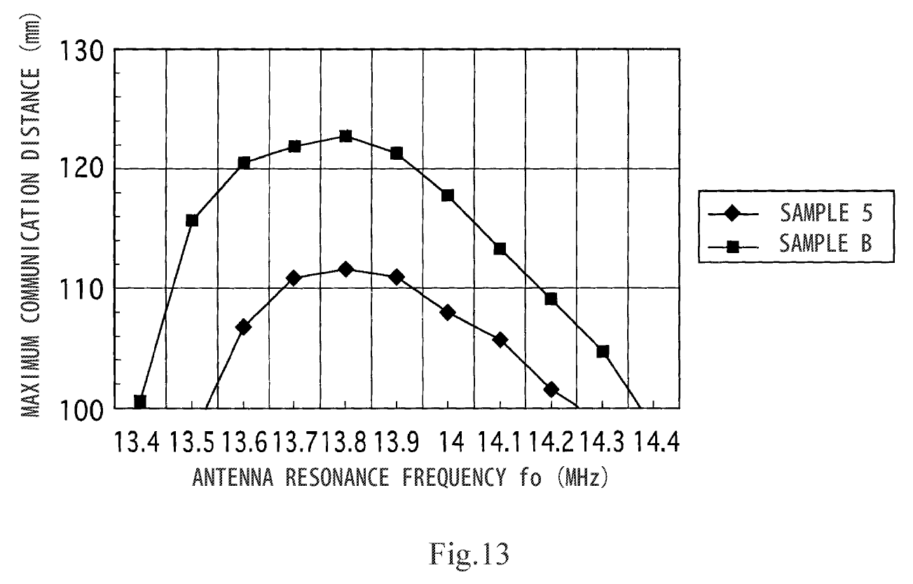

Samples B and C have a very high performance index and a long communication distance. As compared to Sample of the first embodiment compared in Table 2, although μ′ is small, μ″ is smaller than μ′. It can be understood from this that an eddy current loss can be made smaller with a magnetic core member made of sintered ferrite than with a magnetic core member made of composite material. This is apparent from the coil resistance of the antenna characteristics. FIG. 13 shows the antenna resonance frequency characteristics comparing the communication distances of Sample B and the above-mentioned Sample 5. It can be seen that a communication distance of Sample B (sintered ferrite) is longer than that of Sample 5 (composite material) over the whole frequency range.

The embodiments of the present invention have been described above, and it is obvious that the present invention is not limited to the embodiments, but various modifications are possible on the basis of the technical thought of the present invention.

For example, in the above embodiments, description has been made on an example of the structure of the antenna module 10 in which the antenna coil 15 together with the signal processing circuit unit 16 is mounted on the base substrate. The present invention is also applicable to a case where only the antenna coil 15 is mounted on the base substrate 14 and the signal processing circuit unit 16 is mounted on another substrate (e.g., the printed circuit board 12 of the portable information terminal 1).

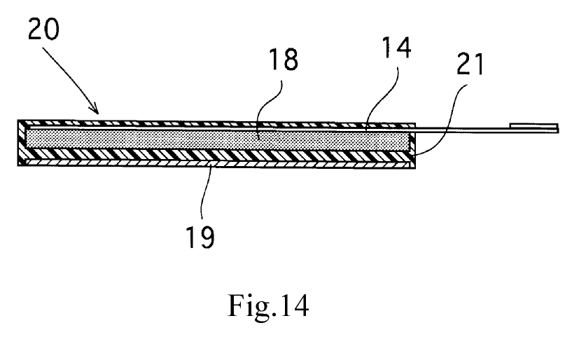

In a case where sintered ferrite is used for the magnetic core member, the antenna module may be structured as shown in FIG. 14. In an antenna module 20 shown in the figure, a magnetic core member 18 made of sintered ferrite is stacked on a base substrate 14 having mounted thereon an antenna coil (and a signal processing circuit unit), and this stacked structure is molded with synthetic resin material, and a metal shield plate 19 is adhered to a non-communication surface (lower side in FIG. 14) of a sealing layer 21. With this arrangement, sintered ferrite which is easy to be cracked and bad in handling, can be applied easily to the magnetic core member.

### INDUSTRIAL APPLICABILITY

As described so far, according to the magnetic core member of the present invention, it is possible to improve the communication distance without increasing a thickness of the magnetic core member so that the antenna module can be made thin and light. Accordingly the antenna module can be built in the housing of a portable information terminal or the like at a small mount space, the communication performance of the antennal module disposed in the housing can be suppressed from being degraded and a target communication distance is ensured.

1. An antenna module-use magnetic core member to be stacked on an antenna coil, characterized in that:
said antenna module-use magnetic core member has a performance index, expressed by μ′×Q, of 300 or higher, where a reciprocal of a loss factor (tan δ=μ″/μ′) expressed by a real part μ′ and an imaginary part μ″ of a complex permeability at an applied frequency is set as Q.

2. The antenna module-use magnetic core member according to claim 1, characterized in that:
the magnetic core member is made of a composite magnetic material formed by mixing soft magnetic powders with a binder.

3. The antenna module-use magnetic core member according to claim 2, characterized in that:
said soft magnetic powders are a crystalline or amorphous alloy material containing Fe.

4. The antenna module-use magnetic core member according to claim 1, characterized in that said magnetic core member is made of a ferrite material.

5. The antenna module-use magnetic core member according to claim 4, characterized in that:
said ferrite material is formed with a material composition in which a resonance frequency of a rotation magnetic resonance of said ferrite material is on a higher frequency side than said applied frequency.

6. The antenna module-use magnetic core member according to claim 5, characterized in that:
said ferrite material is a sintered powder member of bulk ferrite containing Fe₂O₃ of 47.0 to 49.8 mol %, NiO of 16.0 to 33.0 mol %, ZnO of 11.0 to 25.0 mol % and CuO of 7.0 to 12.0 mol %.

7. The antenna module-use magnetic core member according to claim 6, characterized in that:
said bulk ferrite contains CoO of 0.1 to 1.0 wt %.

8. The antenna module-use magnetic core member according to claim 1, characterized in that:
said applied frequency is 13.58 MHz.

9. An antenna module having a magnetic core member stacked on a support member formed with an antenna coil, characterized in that:
said antenna module has a performance index, expressed by μ′×Q, of 300 or higher where a reciprocal of a loss factor (tan δ=μ″/μ′) expressed by a real part μ′ and an imaginary part μ″ of a complex permeability at an applied frequency is set as Q.

10. The antenna module according to claim 9, characterized in that:
a metal shield plate is stacked on a surface of said magnetic core member on a side opposite to a side facing said support member.

11. The antenna module according to claim 9, characterized in that:
a signal processing circuit unit electrically connected to said antenna coil is mounted on said support member in an area on an inner circumference side of said antennal coil.

12. The antenna module according to claim 11, characterized in that:
said signal processing circuit unit is mounted on a surface of said support member on a side of said magnetic core member, and
said magnetic core member is formed with an opening for accommodating said signal processing circuit unit.

13. The antenna module according to claim 9, characterized in that said magnetic core member is made of sintered ferrite and molded with a synthetic resin material.

14. A portable information terminal having incorporated in a housing a support member for supporting an antenna coil, a signal processing circuit unit electrically connected to said antenna coil and disposed on an inner circumferential side of said antenna coil, a magnetic core member stacked on said support member and a metal shield plate stacked on said antenna coil, said portable information terminal being characterized in that:
said magnetic core member has a performance index, expressed by μ′×Q, of 300 or higher, where a reciprocal of a loss factor (tan δ=μ″/μ′) expressed by a real part μ′ and an imaginary part μ″ of a complex permeability at an applied frequency is set as Q.
